(19) United States
(12) Patent Application Publication
(10) Pub. No.: US 2026/0296553 A1
(43) Pub. Date: Oct. 1, 2026

(54) VEHICLE IMPACT-ABSORBING STRUCTURE

(71) Applicant: SUBARU CORPORATION, Tokyo (JP)

(72) Inventor: Hayato ABE, Tokyo (JP)

(73) Assignee: SUBARU CORPORATION, Tokyo (JP)

(21) Appl. No.: 19/569,846

(22) Filed: Mar. 17, 2026

(30) Foreign Application Priority Data
Mar. 26, 2025 (JP) 2025-052395

(51) Int. Cl. B62D 21/15

(52) U.S. Cl. CPC B62D 21/157

(57) ABSTRACT

A vehicle impact-absorbing structure includes an impact-absorbing member. The impact-absorbing member is mounted at a coupling part between a vehicle body and a protected member mounted inside the vehicle body. The impact-absorbing member has a ring shape and constrains a positional relationship between a vehicle body-side constrained member and a protected member-side constrained member disposed facing the vehicle body-side constrained member. At least a portion of the impact-absorbing member contains a fiber extending in a circumferential direction of the ring shape. The impact-absorbing member includes, in a ring width direction of the impact-absorbing member, portions differing in a distance between a ring inner wall of the impact-absorbing member and the vehicle body-side constrained member or the protected member-side constrained member.

### CROSS-REFERENCE TO RELATED APPLICATIONS

The present application claims priority from Japanese Patent Application No. 2025-052395 filed on Mar. 26, 2025, the entire contents of which are hereby incorporated by reference.

### BACKGROUND

The technique of the disclosure relates to a vehicle impact-absorbing structure.

In fixing a battery case and the vehicle body side to each other in a vehicle such as an automobile, there has been proposed a structure that absorbs impact energy while protecting a battery when an external impact is input.

For example, Japanese Unexamined Patent Application Publication (JP-A) No. 2017-144825 discloses a structure having the following configuration for preventing damage to a vehicle battery while preventing the vehicle battery from falling off a vehicle body during a side collision. An inner wall portion of a right-side floor frame is disposed facing a right-side wall portion of a battery. Bearing parts of hinge mechanisms are fixed so as to be arranged one behind the other. A pair of such front and rear hinge mechanisms each include a rotating shaft (rotating part) extending forward and rearward, a shaft support pivotably supporting the rotating shaft, and the rotating part formed as one body with the rotating shaft. The bearing part has an elongated hole in which a left-right diameter is longer than an upper-lower diameter. A relative distance of the battery and the floor frame in a left-right direction is changeable. An input load is converted into a load for displacing the battery downward.

### SUMMARY

An aspect of the technique of the disclosure provides a vehicle impact-absorbing structure including an impact-absorbing member. The impact-absorbing member is mounted at a coupling part between a vehicle body and a protected member mounted inside the vehicle body. The impact-absorbing member has a ring shape and constrains a positional relationship between a vehicle body-side constrained member and a protected member-side constrained member disposed facing the vehicle body-side constrained member. At least a portion of the impact-absorbing member contains a fiber extending in a circumferential direction of the ring shape. The impact-absorbing member includes, in a ring width direction of the impact-absorbing member, portions differing in a distance between a ring inner wall of the impact-absorbing member and the vehicle body-side constrained member or the protected member-side constrained member.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic perspective view of an overall configuration of a vehicle including an impact-absorbing structure according to an embodiment;

FIG. 2 is a schematic plan view of an overall configuration of a vehicle body including the impact-absorbing structure according to the embodiment;

FIG. 3 is a sectional view of a configuration example of the impact-absorbing structure according to the embodiment;

FIG. 4 is an enlarged view of the vicinity of an impact-absorbing member in FIG. 3;

FIG. 5 is a sectional view taken along line V-V in FIG. 3;

FIG. 6 is a sectional view taken along line VI-VI in FIG. 3;

FIGS. 7A to 7C are transition diagrams according to the embodiment;

FIG. 8 illustrates a modification according to the embodiment;

FIG. 9 illustrates another modification according to the embodiment;

FIG. 10 illustrates another modification according to the embodiment;

FIG. 11 illustrates another modification according to the embodiment;

FIG. 12 is a schematic perspective view of an impact-absorbing structure according to an embodiment;

FIG. 13 is a schematic perspective view of an impact-absorbing structure according to an embodiment;

FIG. 14 is a schematic perspective view of an impact-absorbing structure according to an embodiment;

FIG. 15 is a schematic perspective view of an impact-absorbing structure according to an embodiment;

FIG. 16 is a sectional view taken along line XVI-XVI in FIG. 15; and

FIG. 17 is a sectional view taken along line XVII-XVII in FIG. 15.

### DETAILED DESCRIPTION

In the main method used in existing configurations including the configuration of JP-A No. 2017-144825, a member that absorbs impact energy is disposed so as to cover the outer side of a battery case. Such a member that absorbs impact energy is often made of a metal, and the existing configurations thus have room for improvement in terms of weight reduction.

It is desirable to provide a vehicle impact-absorbing structure that is lighter in weight while enabling protection of a battery and absorption of impact energy.

Hereinafter, embodiments of the disclosure will be described in detail with reference to the accompanying drawings. The specific dimensions, materials, numerical values, and the like given in the following embodiments are merely examples for facilitating the understanding of the disclosure and are not intended to limit the disclosure unless otherwise specified. Note that, in the present specification and the drawings, the description of constituent elements having substantially the same function configurations is omitted without repetition by denoting the constituent elements by the same reference signs.

### First Embodiment

### Outline Configuration of Vehicle

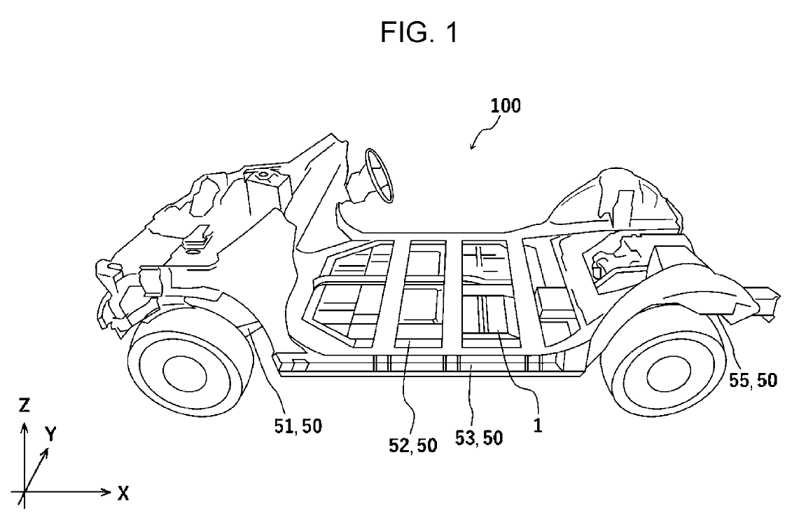

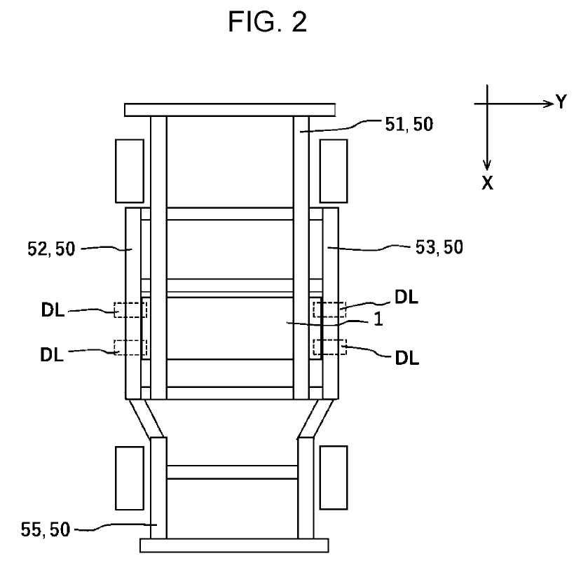

First, an outline configuration of a vehicle including an impact-absorbing structure according to a first embodiment of the disclosure will be described. FIG. 1 is a schematic perspective view mainly illustrating a vehicle body part of a vehicle 100. FIG. 2 is a schematic plan view mainly illustrating the vehicle body part of the vehicle 100. The direction along the arrow X in each of the following drawings represents a front-rear (vehicle length) direction of the vehicle, and the direction of the arrow X indicates the rear of the vehicle. The direction along the arrow Y in each of the drawings represents a left-right (vehicle width) direction of the vehicle, and the direction of the arrow Y indicates the right side of the vehicle. The direction along the arrow Z in each of the drawings represents a height direction of the vehicle, and the direction of the arrow Z indicates the upper side of the vehicle.

The vehicle 100 is, for example, a hybrid vehicle that travels by one or more of power from fuel (such as gasoline) and power from electricity. Alternatively, the vehicle 100 may be an electric vehicle that travels only by power from electricity.

The vehicle 100 includes a power source (not illustrated) and an in-vehicle battery 1. The in-vehicle battery 1 may be mounted at a known spot of a vehicle body 50. The vehicle body 50 includes a floor panel (not illustrated), front side members 51, floor side members 52, side sills 53, rear side members 55, and the like. In one example, the in-vehicle battery 1 is mounted to the side sills 53 or the floor side members 52 by impact-absorbing structures DL according to the first embodiment of the disclosure. Note that, in FIG. 2, four impact-absorbing structures DL are provided at four spots in the vehicle 100, but the configuration is one option, and the impact-absorbing structures DL may be disposed at appropriate intervals.

Two front side members 51 are disposed parallel to each other from the front positions of the vehicle body 50 towards backward. The two front side members 51 are each disposed in an elongated shape between the bumper side and the vehicle cabin side when viewed in the front-rear direction of the vehicle.

The floor side members 52 are a pair of left and right frame members extending in the vehicle front-rear direction on the vehicle cabin side. The in-vehicle battery 1 is disposed, under a floor, between the pair of left and right floor side members 52. The in-vehicle battery 1 is fixed to the floor side members 52 or the side sills 53, which will be described later, at multiple spots along the vehicle front-rear direction. The in-vehicle battery 1 is fixed by using a vehicle impact-absorbing member, which will be described later.

Two rear side members 55 are disposed parallel to each other from the rear positions of the vehicle body 50 towards backward. Wheel housings of left and right rear wheels are positioned on the outer sides relative to the right and left rear side members 55.

The side sills 53 are a pair of left and right frame members extending along the vehicle front-rear direction, on the outer sides relative to the floor side members 52 in the vehicle width direction (sides of the vehicle body).

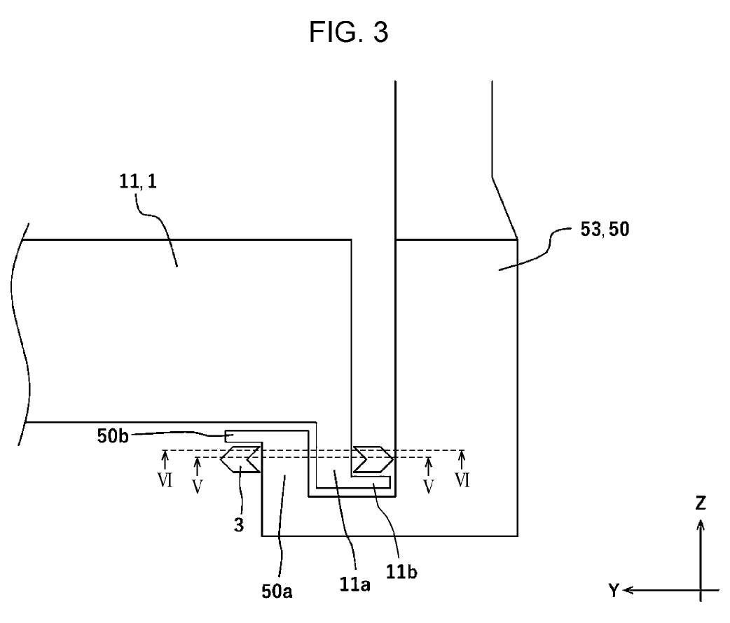

FIG. 3 is an enlarged sectional view of the impact-absorbing structure DL of the embodiment of the disclosure. As illustrated in FIG. 3 and the like, on the inner side of the side sill 53 (the vehicle cabin side), a vehicle body-side pin 50a (a vehicle body-side constrained member) protrudes upward of the vehicle and is erected. The vehicle body-side pin 50a may be fixed to the side sill 53 by welding or the like or may be formed into one body with the side sill 53.

### Impact-Absorbing Structure DL

The impact-absorbing structure DL of the embodiment of the disclosure includes a mounting structure of the in-vehicle battery 1 using the vehicle body-side pin 50a. The in-vehicle battery 1 (a protected member) includes a housing case 11 formed into a horizontally elongated box shape and a battery module (not illustrated) housed in the housing case 11. As illustrated in FIG. 3, the housing case 11 is provided with a battery-side pin 11a (a protected member-side constrained member, a protected member-side pin) protruding downward of the vehicle. The battery-side pin 11a is disposed between the side sill 53 and the vehicle body-side pin 50a in sectional view. That is, the battery-side pin 11a and the vehicle body-side pin 50a are disposed facing each other.

As illustrated in FIG. 3, an impact-absorbing ring 3 (an impact-absorbing member) is disposed around the vehicle body-side pin 50a and the battery-side pin 11a. That is, the impact-absorbing ring 3 is mounted at a coupling part between the vehicle body-side pin 50a and the battery-side pin 11a. In addition, the impact-absorbing ring 3 constrains the positional relationship between the vehicle body-side pin 50a and the battery-side pin 11a. In other words, the coupling between the housing case 11 of the in-vehicle battery 1 and the side sill 53 is achieved by using the impact-absorbing ring 3. This coupling suppresses the housing case 11 from moving in the X and Y directions under normal circumstances.

Note that, moreover, the vehicle body-side pin 50a may be provided with, for example, a vehicle body-side plate 50b protruding on the vehicle cabin side along the Y direction. In addition, the battery-side pin 11a may be provided with a battery-side plate 11b protruding, along the Y direction, in the opposite direction to the direction where the vehicle body-side plate 50b protrudes. By disposing the impact-absorbing ring 3 around the vehicle body-side pin 50a and the battery-side pin 11a at a position between the vehicle body-side plate 50b and the battery-side plate 11b, the vehicle body-side plate 50b and the battery-side plate 11b have the function of further improving the constraint of the positional relationship in the Z direction. Note that the vehicle body-side plate 50b and the battery-side plate 11b are optional but can be used to suppress the housing case 11 from moving in the Z direction under normal circumstances.

FIG. 5 is a sectional view taken along line V-V in FIGS. 3, and 6, is a sectional view taken along line VI-VI in FIG. 3. As illustrated in FIGS. 3 to 6, the impact-absorbing ring 3 is a ring-shaped member disposed in a surrounding manner between the vehicle body-side pin 50a and the battery-side pin 11a. The impact-absorbing ring 3 is made of a fiber-reinforced resin containing a fiber extending in a circumferential direction of the impact-absorbing ring 3.

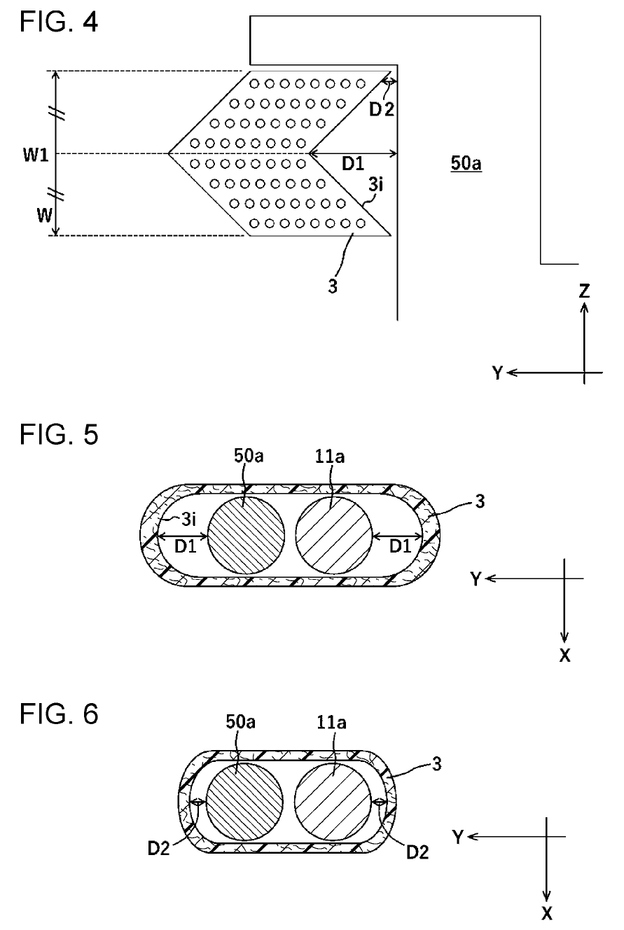

Note that the pattern of an inner part of the impact-absorbing ring 3 illustrated in FIG. 4 and the like schematically illustrates the sections of fibers contained in the impact-absorbing ring 3. However, the amount and/or the thickness of the fibers are not necessarily limited thereto, and at least a portion of the inner part of the impact-absorbing ring 3 may simply contain a fiber extending in the circumferential direction. Note that the fiber-reinforced resin constituting the impact-absorbing ring 3 may be a composite, examples of which may include a member made mainly by a fiber-reinforced resin such as carbon fiber-reinforced plastic (hereinafter, referred to as CFRP) and including a metal reinforcement and/or a metal fastening member.

The composite using a fiber-reinforced resin, typified by CFRP, has high rigidity and exhibits high strength against the compressive stress or the tensile stress acting in the direction of fiber orientation in one example. The fiber-reinforced resin-made composite is obtained by forming a fiber-reinforced resin that contains reinforced fiber mainly made of carbon fiber and/or aramid fiber and contains a matrix resin made of a thermoplastic resin or a thermosetting resin. However, the kind of the reinforced fiber is not limited to carbon fiber or aramid fiber. In addition, various fibers may be used as the reinforced fiber.

Examples of the thermoplastic resin include a polyethylene resin, a polypropylene resin, a polyvinyl chloride resin, an ABS resin (acrylonitrile-butadiene-styrene copolymer synthetic resin), a polystyrene resin, an AS resin (acrylonitrile-styrene copolymer synthetic resin), a polyamide resin, a polyacetal resin, a polycarbonate resin, a polyester resin, a PPS (polyphenylene sulfide) resin, a fluorocarbon resin, a polyetherimide resin, a polyether ketone resin, and a polyimide resin. The matrix resin may be one kind of or a mixture of two or more kinds of the above-described thermoplastic resins. The matrix resin may alternatively be a copolymer of the above-described thermoplastic resins. When the thermoplastic resin is such a mixture, a compatibilizer may further be used together. Furthermore, a flame retardant, examples of which include a bromine-based flame retardant, a silicon-based flame retardant, and red phosphorus, may be added to the thermoplastic resin.

Examples of the thermosetting resin include an epoxy resin, an unsaturated polyester resin, a vinyl ester resin, a phenol resin, a polyurethane resin, and a silicon resin. The matrix resin may be one kind of or a mixture of two or more kinds of the above-described thermosetting resins. When any one or more of the above-described thermosetting resins are used, an appropriate curing agent and/or an appropriate reaction accelerator may be added thereto.

The impact-absorbing ring 3 includes, in a width direction thereof (that is, the height direction of the vehicle), portions differing in the distance between an inner wall 3i and the vehicle body-side pin 50a. For example, as illustrated in FIG. 4, the impact-absorbing ring 3 has a width W in the Z direction, and a distance D1 between the inner wall 3i of the impact-absorbing ring 3 and the vehicle body-side pin 50a at a width center W1 of the width W is longer than a distance D2 between the inner wall 3i of the impact-absorbing ring 3 and the vehicle body-side pin 50a at an upper end of the impact-absorbing ring 3 (D1 > D2). Similarly, it can also be said that the impact-absorbing ring 3 includes, in the width direction thereof, portions differing in the distance between the inner wall 3i and the battery-side pin 11a.

As described above, the impact-absorbing ring 3 is configured so that a center portion and an end portion in the ring width direction mutually differ in the distance from the vehicle body-side pin 50a or the battery-side pin 11a. However, the shape of the impact-absorbing ring 3 is not limited to the above-described shape as long as the impact-absorbing ring 3 includes such portions differing in the distance between the ring inner wall and a corresponding one of the above-described pins. Note that modifications of the shape of the impact-absorbing ring 3 will be described later.

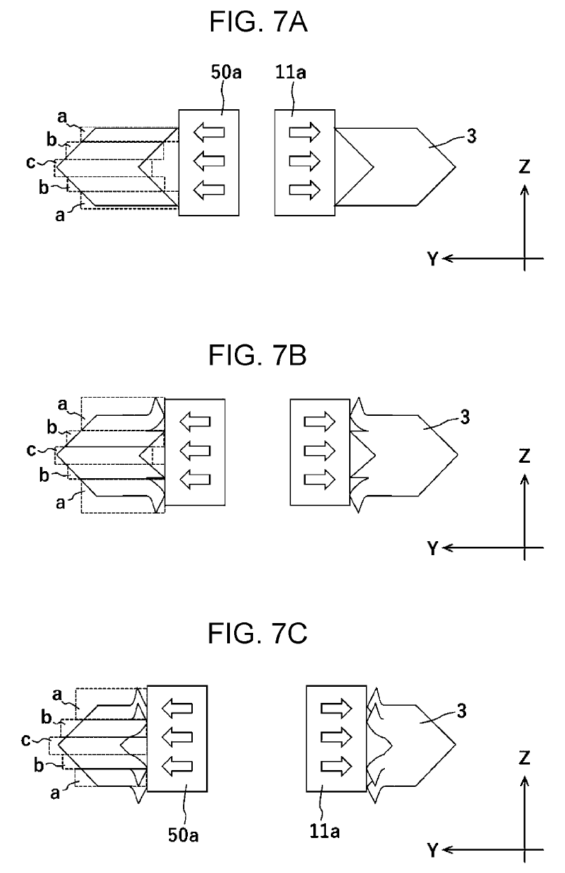

Rupture of the impact-absorbing ring 3 when an impact is input from the lateral side of the vehicle will be described using FIG. 7. As illustrated in FIG. 7A, the load input from the lateral side of the vehicle is transmitted to the vehicle body-side pin 50a and is also transmitted to the battery-side pin 11a through the impact-absorbing ring 3. The transmitted load moves the vehicle body-side pin 50a and the battery-side pin 11a in respective directions where the vehicle body-side pin 50a and the battery-side pin 11a move away from each other. Accordingly, the impact-absorbing ring 3 receives a tensile load and is sequentially ruptured starting from portions closer to the vehicle body-side pin 50a or the battery-side pin 11a.

As a more detailed example, as illustrated in FIGS. 7A to 7C, first, a portion (region a) in the impact-absorbing ring 3 closest to the vehicle body-side pin 50a or the battery-side pin 11a ruptures so as to curl up and lift, from the ring inner wall side. Subsequently, following the region a, the load is transferred to a region b that is next closest, and rupture from the ring inner wall side continues. Finally, the load is transferred to a portion (region c) that is farthest from the vehicle body-side pin 50a or the battery-side pin 11a, and the impact-absorbing ring 3 is ruptured.

As described above, the impact-absorbing ring 3 according to the present embodiment includes, in the ring width direction, portions differing in the distance between the ring inner wall and the vehicle body-side pin 50a or the battery-side pin 11a. With the above-described configuration, the impact load input from the lateral side of the vehicle causes sequential rupture of the impact-absorbing ring 3, and a protected member, such as the in-vehicle battery 1, and the like can be protected.

### First Modification

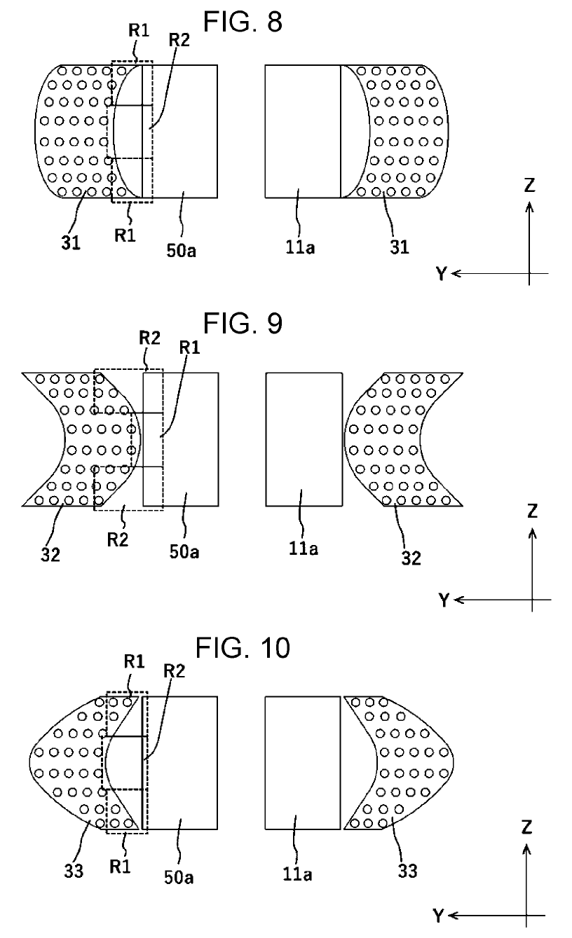

Different from the impact-absorbing ring 3 in the first embodiment having an arrow-fletching shape in sectional view, in a first modification, as illustrated in FIG. 8, an impact-absorbing ring 31 has a parenthesis shape in sectional view. Thus, in the first modification, the difference is mainly described, and the description of common features is omitted while the common features are denoted by common reference signs.

In the first modification, in the impact-absorbing ring 31, in a width direction thereof, a region R1 in which the distance between an inner wall of the impact-absorbing ring 31 and the vehicle body-side pin 50a is close is provided in the vicinity of each of upper and lower ends, and a region R2 in which the distance between the inner wall of the impact-absorbing ring 31 and the vehicle body-side pin 50a is far is provided in the vicinity of a ring center. As described above, the distance of the impact-absorbing ring 31 from the vehicle body-side pin 50a or the battery-side pin 11a differs in the ring width direction. As with the above-described first embodiment, this configuration exhibits an effect of appropriately protecting a protected member, such as the in-vehicle battery 1, and the like.

### Second Modification

In a second modification, as illustrated in FIG. 9, in an impact-absorbing ring 32, in a width direction thereof, a region R1 in which the distance between an inner wall of the impact-absorbing ring 32 and the vehicle body-side pin 50a is close is provided in the vicinity of the center, and a region R2 in which the distance between the inner wall of the impact-absorbing ring 32 and the vehicle body-side pin 50a is far is provided in the vicinity of each of upper and lower ends of the ring. As described above, the distance of the impact-absorbing ring 32 from the vehicle body-side pin 50a or the battery-side pin 11a differs in the ring width direction. As with the above-described first embodiment, this configuration exhibits an effect of appropriately protecting a protected member, such as the in-vehicle battery 1, and the like.

### Third Modification

In a third modification, as illustrated in FIG. 10, in an impact-absorbing ring 33, in a width direction thereof, a region R1 in which the distance between an inner wall of the impact-absorbing ring 33 and the vehicle body-side pin 50a is close is provided in the vicinity of each of upper and lower ends, and a region R2 in which the distance between the inner wall of the impact-absorbing ring 33 and the vehicle body-side pin 50a is far is provided in the vicinity of a ring center. Moreover, the thickness of a portion of the impact-absorbing ring 33 in the vicinity of the region R2 is larger than the thickness of a portion of the impact-absorbing ring 33 in the vicinity of the region R1. As with the above-described first embodiment, this configuration exhibits an effect of appropriately protecting a protected member, such as the in-vehicle battery 1, and the like.

### Fourth Modification

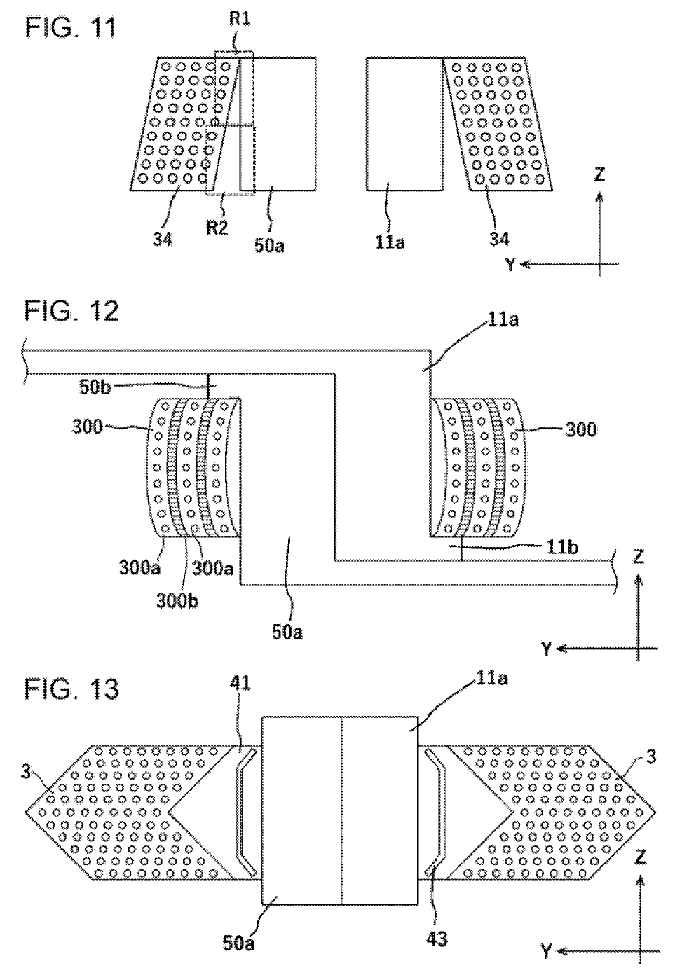

In a fourth modification, as illustrated in FIG. 11, an impact-absorbing ring 34 has an inversely-tapered shape that widens in a downward direction of the vehicle body. That is, in the impact-absorbing ring 34, a region R1 in which the distance between an inner wall of the impact-absorbing ring 34 and the vehicle body-side pin 50a is close is provided in an upward direction of the vehicle body, and a region R2 in which the distance between the inner wall of the impact-absorbing ring 34 and the vehicle body-side pin 50a is far is provided in the downward direction of the vehicle body. As with the above-described first embodiment, this configuration exhibits an effect of appropriately protecting a protected member, such as the in-vehicle battery 1, and the like.

### Second Embodiment

Subsequently, a vehicle impact-absorbing structure according to a second embodiment of the disclosure will be described.

Different from the first embodiment in which the impact-absorbing ring 3 is constituted by a unidirectional fiber-reinforced resin layer as a whole, in the second embodiment, an impact-absorbing ring 300 includes a unidirectional fiber-reinforced resin layer 300a and a different-direction fiber-reinforced resin layer 300b. Thus, in the second embodiment, the difference is mainly described, and the description of common features is omitted while the common features are denoted by common reference signs.

As illustrated in FIG. 12, the impact-absorbing ring 300 in the second embodiment includes the unidirectional fiber-reinforced resin layer 300a and the different-direction fiber-reinforced resin layer 300b adjacent to the unidirectional fiber-reinforced resin layer 300a. Note that, in FIG. 12, the configuration constituted by in total five layers including three unidirectional fiber-reinforced resin layers 300a and the different-direction fiber-reinforced resin layers 300b each interposed between the unidirectional fiber-reinforced resin layers 300a is given but is one option.

In the second embodiment, the unidirectional fiber-reinforced resin layer 300a may be constituted by a fiber-reinforced resin containing a fiber extending in a circumferential direction of the unidirectional fiber-reinforced resin layer 300a, as with the impact-absorbing ring 3 of the above-described first embodiment. At least a portion of the unidirectional fiber-reinforced resin layer 300a may simply contain a fiber extending in a ring circumferential direction of the impact-absorbing ring 300.

In the second embodiment, the different-direction fiber-reinforced resin layer 300b is provided adjacent to the unidirectional fiber-reinforced resin layer 300a. Note that the different-direction fiber-reinforced resin layer 300b may be laminated directly on the unidirectional fiber-reinforced resin layer 300a or may be laminated thereon with a known adhesive or the like therebetween.

In the second embodiment, the different-direction fiber-reinforced resin layer 300b contains a fiber extending in a different direction from the direction, that is, the ring circumferential direction, where a fiber contained in the unidirectional fiber-reinforced resin layer 300a extends. The kind of the fiber contained in the different-direction fiber-reinforced resin layer 300b may be the same as or different from the kind of the fiber of the unidirectional fiber-reinforced resin layer 300a. The different-direction fiber-reinforced resin layer 300b may contain, in an appropriate ratio, fibers oriented in an axial direction of the impact-absorbing ring 300 and fibers oriented in a direction intersecting the axial direction. The different-direction fiber-reinforced resin layer 300b may contain short fibers cut to a few millimeters in length besides continuous fibers continuously extending in a predetermined direction. In one example, the different-direction fiber-reinforced resin layer 300b may be constituted by a layer of chopped carbon fiber. The impact-absorbing ring 300 in the present embodiment may be a composite member including a metal reinforcement and/or a metal fastening member.

In the present embodiment, even when the directions where the tensile load is applied to the impact-absorbing ring 300 include a direction other than the Y direction, the configuration in which the different-direction fiber-reinforced resin layer 300b is disposed enables to cause sequential rupture in the impact-absorbing ring 300.

### Third Embodiment

Subsequently, a vehicle impact-absorbing structure according to a third embodiment of the disclosure will be described.

Different from the first embodiment and the second embodiment, the third embodiment includes an inner rubber ring 41 between the impact-absorbing ring 3 and the vehicle body-side pin 50a or the battery-side pin 11a. Thus, in the third embodiment, the difference is mainly described, and the description of common features is omitted while the common features are denoted by common reference signs.

As illustrated in FIG. 13, in the third embodiment, the inner rubber ring 41 is disposed on the inner side relative to the impact-absorbing ring 3 and on the outer side relative to the vehicle body-side pin 50a or the battery-side pin 11a. That is, the vehicle body-side pin 50a and the battery-side pin 11a are coupled to each other by disposing the inner rubber ring 41 therearound, and the impact-absorbing ring 3 is further disposed around the outer side of the inner rubber ring 41. The inner rubber ring 41 may be disposed in direct contact with the inner wall of the impact-absorbing ring 3 or may be disposed thereon with a known adhesive layer (not illustrated) or the like therebetween. The inner rubber ring 41 and the impact-absorbing ring 3 may also be spaced from each other appropriately.

The material of the inner rubber ring 41 may be a known material having rubber elasticity. Examples of the material having rubber elasticity include a silicone rubber, a fluororubber, a urethane rubber, and a thermoplastic elastomer that are known.

As illustrated in FIG. 13, the inner rubber ring 41 may include a metal ring 43 inside. As illustrated in FIG. 13, the shape of the metal ring 43 is a tortoise-shell bracket shape or a square bracket shape bent toward the vehicle body-side pin 50a or the battery-side pin 11a, but is not limited thereto and may be another shape. The material of the metal ring 43 may be any known metal material, examples of which include stainless steel, aluminum, and iron.

In the present embodiment, by disposing the inner rubber ring 41, the holding force of the impact-absorbing ring 3 can be enhanced, and the impact-absorbing ring 3 can be suppressed from falling off unexpectedly. In addition, by providing the metal ring 43 inside the inner rubber ring 41, even when, for example, the material of the inner rubber ring 41 deteriorates over time, the above-described inner rubber ring 41 can continue to be effective. Note that, in the present embodiment, the metal ring 43 is optional and is not necessarily provided inside the inner rubber ring 41.

### Fourth Embodiment

Subsequently, a vehicle impact-absorbing structure according to a fourth embodiment of the disclosure will be described.

The shape of an impact-absorbing ring 310, the shape of a vehicle body-side pin 500a, and the shape of a battery-side pin 110a in the fourth embodiment differ from the shapes of the equivalent parts of each of the above-described embodiments. Thus, in the fourth embodiment, the difference is mainly described, and the description of common features is omitted while the common features are denoted by common reference signs.

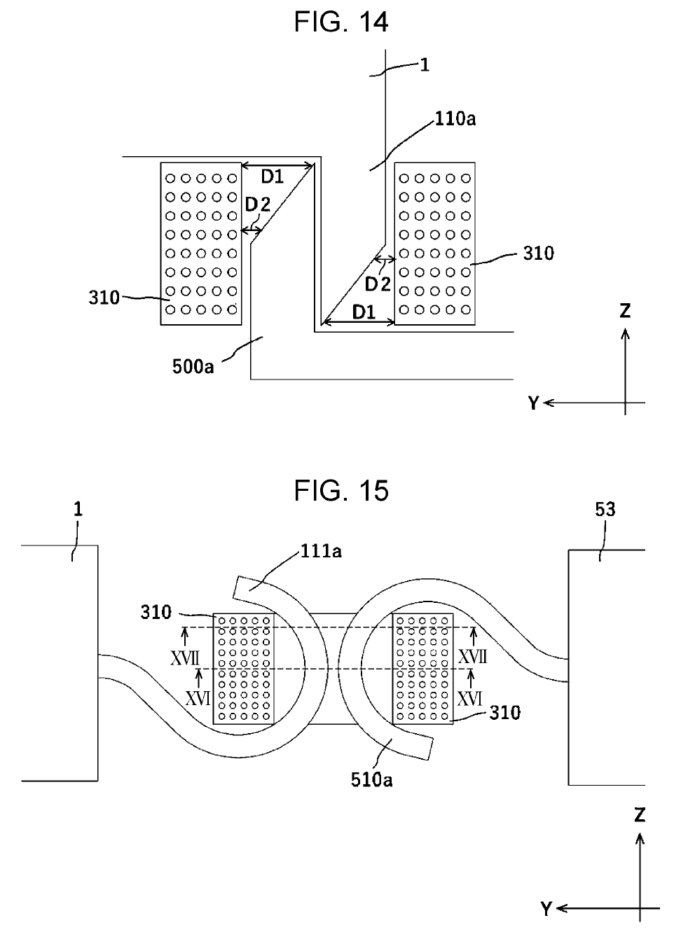

As illustrated in FIG. 14, in the fourth embodiment, the impact-absorbing ring 310 has a flat shape with a constant thickness throughout the Z direction. On the other hand, the shape of the vehicle body-side pin 500a is tapered toward the upper side of the vehicle height. As a result, a distance D1 between an inner wall of the impact-absorbing ring 310 and the vehicle body-side pin 500a at an upper end of the vehicle body-side pin 500a is longer than a distance D2 between the inner wall of the impact-absorbing ring 310 and the vehicle body-side pin 500a at a substantially middle portion of the impact-absorbing ring 310 (D1 > D2). Similarly, the shape of the battery-side pin 110a is tapered toward the lower side of the vehicle height, and, as a result, a distance D1 between the inner wall of the impact-absorbing ring 310 and the battery-side pin 110a at a lower end of the battery-side pin 110a is longer than a distance D2 between the inner wall of the impact-absorbing ring 310 and the battery-side pin 110a at the substantially middle portion of the impact-absorbing ring 310 (D1 > D2).

As described above, in the present embodiment, the impact-absorbing ring 310 includes, in a width direction thereof, portions differing in the distance between the inner wall and the vehicle body-side pin 500a or the battery-side pin 110a. In the present embodiment, even with the impact-absorbing ring 310 having a flat shape, a tensile load can cause sequential rupture starting from portions closer to the vehicle body-side pin 500a or the battery-side pin 110a.

### Fifth Embodiment

Subsequently, a vehicle impact-absorbing structure according to a fifth embodiment of the disclosure will be described.

Different from each of the above-described embodiments, the fifth embodiment includes, instead of the vehicle body-side pin and the battery-side pin, a vehicle body-side hook 510a and a battery-side hook 111a. Thus, in the fifth embodiment, the difference is mainly described, and the description of common features is omitted while the common features are denoted by common reference signs.

As illustrated in FIG. 15, in the fifth embodiment, the impact-absorbing ring 310 has a flat shape with a constant thickness throughout the Z direction. On the other hand, the vehicle body-side hook 510a has a hook shape protruding (in the Y direction) toward the in-vehicle battery 1. Similarly, the battery-side hook 111a has a hook shape protruding (the − Y direction) toward the side sill 53. The impact-absorbing ring 310 is disposed around the vehicle body-side hook 510a and the battery-side hook 111a.

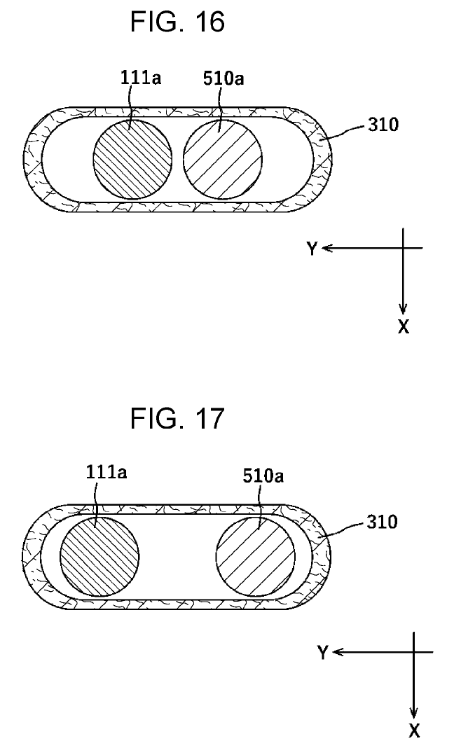

In FIGS. 16 and 17, in the XVI-XVI section and the XVII-XVII section of FIG. 15, the distance between the inner wall of the impact-absorbing ring 310 and the vehicle body-side hook 510a differs. Similarly, the distance between the inner wall of the impact-absorbing ring 310 and the battery-side hook 111a also differs.

As described above, in the present embodiment, even when a load acting in a direction where the vehicle body 50 and the in-vehicle battery 1 are separated from each other is input, a tensile load is applied to the impact-absorbing ring 310 and can cause sequential rupture of the impact-absorbing ring 310.

Although the embodiments of the technique of the disclosure have so far been described in detail with reference to the accompanying drawings, the technique of the disclosure is not limited to the examples. Various modifications or alterations will be apparent to those skilled in the art to which the present disclosure belongs, within the range of the technical idea described in claims, and it is to be understood that the technical scope of the disclosure also encompasses the modifications and alterations.

For example, in each of the above-described embodiments, the example in which the vehicle impact-absorbing structure is used for the side sill of the vehicle body has been described, but the technique of the disclosure is not limited to the above-described example. For example, the vehicle impact-absorbing structure may be used for a structure such as the structure of the front side member, the rear side member, or a roof of the vehicle body.

According to the embodiments of the technique of the disclosure, the lighter and more compact configuration enables protection of a vehicle component such as a battery and absorption of impact energy.

1. A vehicle impact-absorbing structure comprising:
an impact-absorbing member mounted at a coupling part between a vehicle body and a protected member mounted inside the vehicle body, wherein
the impact-absorbing member has a ring shape and constrains a positional relationship between a vehicle body-side constrained member and a protected member-side constrained member disposed facing the vehicle body-side constrained member,
at least a portion of the impact-absorbing member comprises a fiber extending in a circumferential direction of the ring shape, and
the impact-absorbing member comprises, in a ring width direction of the impact-absorbing member, portions differing in a distance between a ring inner wall of the impact-absorbing member and the vehicle body-side constrained member or the protected member-side constrained member.

2. The vehicle impact-absorbing structure according to claim 1, wherein
the vehicle body-side constrained member is a vehicle body-side pin erected on at least a portion of the vehicle body,
the protected member-side constrained member is a protected member-side pin erected on at least a portion of the protected member or at least a portion of a case of the protected member, and,
in the impact-absorbing member having the ring shape, a center portion and an end portion in the ring width direction mutually differ in a distance from the vehicle body-side pin or the protected member-side pin.

3. The vehicle impact-absorbing structure according to claim 1, wherein
the vehicle body-side constrained member and the protected member-side constrained member each have a shape with which a distance from a portion of the shape to a center portion, in the ring width direction, of the ring shape and a distance from a portion of the shape to an end portion, in the ring width direction, of the ring shape mutually differ.

4. The vehicle impact-absorbing structure according to claim 1, wherein
the impact-absorbing member comprises a different-direction fiber-reinforced resin layer comprising a fiber extending in a direction different from the circumferential direction.

5. The vehicle impact-absorbing structure according to claim 1, further comprising:
an inner rubber ring disposed between the impact-absorbing member and the vehicle body-side constrained member or the protected member-side constrained member.

6. The vehicle impact-absorbing structure according to claim 5, wherein
the inner rubber ring comprises a metal ring inside the inner rubber.

7. The vehicle impact-absorbing structure according to claim 1, wherein
the vehicle body-side constrained member and the protected member-side constrained member further comprise, at distal ends, plates protruding in opposite directions along a vehicle width direction, and
the impact-absorbing member is disposed between the plates.
